(19) United States
(12) Patent Application Publication
(10) Pub. No.: US 2017/0198726 A1
(43) Pub. Date: Jul. 13, 2017

(54) Hydraulic Rotary Actuator

(71) Applicants: Joseph A. Worley, Fletcher, NC (US); Andrew W. G. Wylie, Fletcher, NC (US); Jame F. Silliman, Fletcher, NC (US); Kevin C. Howe, Fletcher, NC (US)

(72) Inventors: Joseph A. Worley, Fletcher, NC (US); Andrew W. G. Wylie, Fletcher, NC (US); Jame F. Silliman, Fletcher, NC (US); Kevin C. Howe, Fletcher, NC (US)

(21) Appl. No.: 14/990,600

(22) Filed: Jan. 7, 2016

(51) Int. Cl. F15B 7/00

(52) U.S. Cl. CPC F15B 7/008

(57) ABSTRACT

A hydraulic rotational actuator is provided for imparting rotational resistance, or powered rotation, thereby allowing for complete control of shaft, or axle, rotation or rotational resistance within the range of rotation. The hydraulic rotational actuator comprises a casing comprising a pair of cylinders with fluid in each cylinder. A pair of ports is in flow communication within each other wherein each port of is in flow relationship with a separate cylinder. A controller is provided which is capable of controlling flow of fluid between ports. A pair of pistons is provided wherein each piston is in a separate cylinder and engaged with the fluid such that the piston moves in the cylinder in response to fluid volume changing in the cylinder. A pair of connector rods is provided wherein each connector rod is pivotally attached to a separate piston. A pivot plate is pivotally connected to each connector rod opposite the piston and a shaft is attached to the pivot plate and adapted to rotate in concert with the pivot plate.

### BACKGROUND OF THE INVENTION

The instant invention is generally related to a rotary actuator providing rotational control, resistive or powered, throughout a range of rotation. More specifically, the instant invention is related to a hydraulic rotary actuator wherein rotational resistance is hydraulically controlled throughout the range of rotation.

Many devices utilize rotational resistance wherein resistance to rotation is provided to an axle, or shaft, to mitigate free rotational movement of a device integral thereto. Rotational resistance is desirable in a number of industries including, without limit: steering mechanisms wherein the resistance is desirable for tactile purposes or to mitigate oversteerage; manufacturing environments wherein the resistance may be used to dampen vibration and braking mechanisms to reduce or terminate angular momentum. Of particular interest is the use of rotational resistance in exercise equipment.

Powered, or active, rotational devices wherein rotation of an axle, or shaft, is controllably rotated are also widely used in such diverse applications as, without limit: automatic closure of doors; lift gates and the like. Of particular interest is the use of powered, or active rotational devices for use in rehabilitation equipment.

Rotational devices typically utilize abrasive members which engage to restrict movement such as in a brake/drum or brake/disk assembly; or by coupling with linear resistance devices such as springs, weights or linear hydraulics. Though effective and relatively easy to operate, these conventional systems lack the control necessary for sophisticated equipment, particularly, sophisticated exercise equipment as currently demanded in the art. Particularly difficult to achieve with conventional resistive rotational devices is a variable resistance within regions of the rotational range. Similarly, powered, or active rotational devices are known yet they lack the level of control desired for modern exercise and rehabilitation equipment. Furthermore, devices which allow for both resistive rotation and powered, or active rotation, are very limited in spite of their need in commerce.

Accordingly, there exists a need for a device which can function for both rotary resistance to rotation and for powered, or active, rotation and which provides a high level of control throughout the range of rotation with consistency and accuracy. These needs are simultaneously met herein.

### SUMMARY OF THE INVENTION

It is an object of the invention to provide a device which provides rotational resistance in a shaft or axle.

It is another object of the invention to provide a device which can provide powered, or active, rotation to a shaft or axle.

A particular feature of the instant invention is the ability to provide a device which can provide rotational resistance, or powered rotation, and which allows for complete control of shaft, or axle, rotation or rotational resistance within the range of rotation.

These and other embodiments, as will be realized, are provided in a hydraulic rotational actuator. The hydraulic rotational actuator comprises a casing comprising a pair of cylinders with fluid in each cylinder. A pair of ports is in flow communication within each other wherein each port of is in flow relationship with a separate cylinder. A controller is provided which is capable of controlling flow of fluid between ports. A pair of pistons is provided wherein each piston is in a separate cylinder and engaged with the fluid such that the piston moves in the cylinder in response to fluid volume changing in the cylinder. A pair of connector rods is provided wherein each connector rod is pivotally attached to a separate piston. A pivot plate is pivotally connected to each connector rod opposite the piston and a shaft is attached to the pivot plate and adapted to rotate in concert with the pivot plate.

### BRIEF DESCRIPTION OF THE DRAWINGS

FIG. 1 is a perspective schematic view of an embodiment of the invention.

FIG. 2 is a partial perspective schematic view of an embodiment of the invention.

FIG. 3 is an exploded schematic view of an embodiment of the invention.

FIG. 4 is a side schematic view of a casing.

FIG. 5 is a top schematic view of a casing.

FIG. 6 is a side schematic view of a pivot plate.

FIG. 7 is a cross-sectional schematic view of an embodiment of the invention.

### DETAILED DESCRIPTION

The invention is directed to a hydraulic rotary actuator. More specifically, the present invention is directed to a hydraulic rotary actuator which allows for control of rotational resistance throughout the range of motion or for control of powered rotation with control exerted throughout the range of motion.

The invention will be described with reference to the various figures forming an integral, non-limiting, component of the disclosure. Throughout the various figures similar elements will be numbered accordingly.

For the purposes of the instant application two types of control are described. Rotational resistance, or similar terms, refers to a passive action wherein the resistance to rotation of the shaft is met with a resistive hydraulic force. Powered rotation, or similar terms, is an active action wherein the hydraulic force is applied thereby ultimately persuading the shaft to rotate.

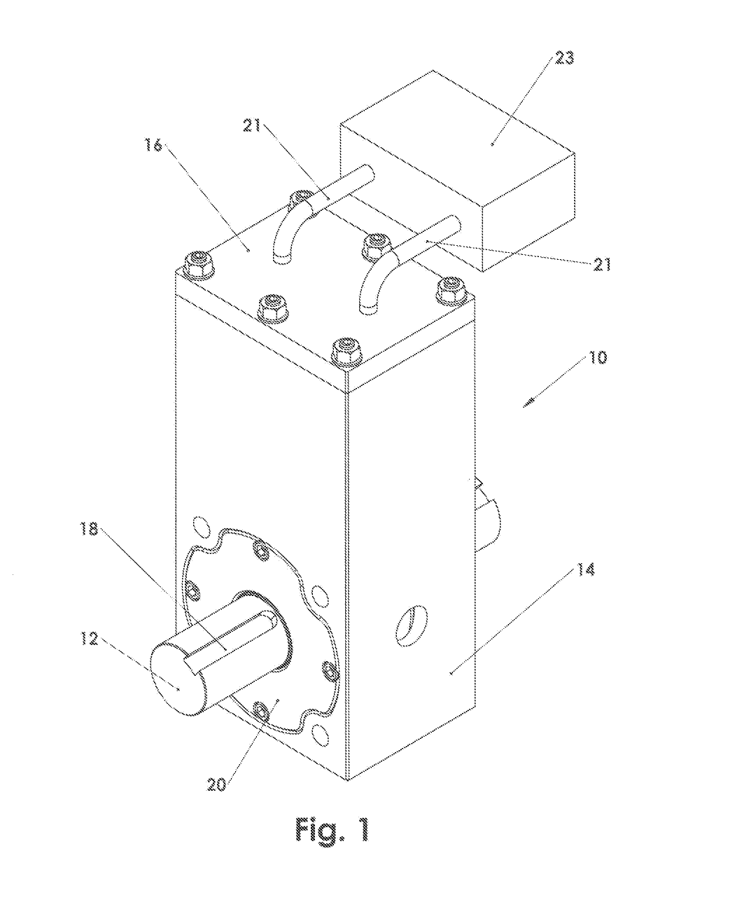

An embodiment of the invention is illustrated in top perspective view in FIG. 1. In FIG. 1, the hydraulic rotary actuator 10 comprises a shaft 12 extending from a casing 14. The casing preferably comprises a header 16 sealing cylinders in the casing as will be more fully described herein. The header comprises ports 21 wherein each port is interfaced with a hydraulic controller 23 as will be more readily described herein. The shaft may extend from a single side of the casing or, as illustrated in FIG. 1, the shaft may extend through the casing. A shaft extending through the casing is preferred due to the options provided thereby. One side of the shaft can be coupled for functional use with the other side coupled to bearings in a frame for stability, thereby functioning as an idler, or both sides can be coupled for functional use which is either in concert or in parallel. For example, both sides can be commonly coupled as redundant drives or they can be separately coupled to control parallel operations. A key retainer slot 18 can be incorporated for coupling with a pulley or the like or the shaft could be a shape other than round to prohibit a pulley or the like from rotating on the shaft. A bearing cap 20 maintains an optional but preferred bearing, not seen, in position.

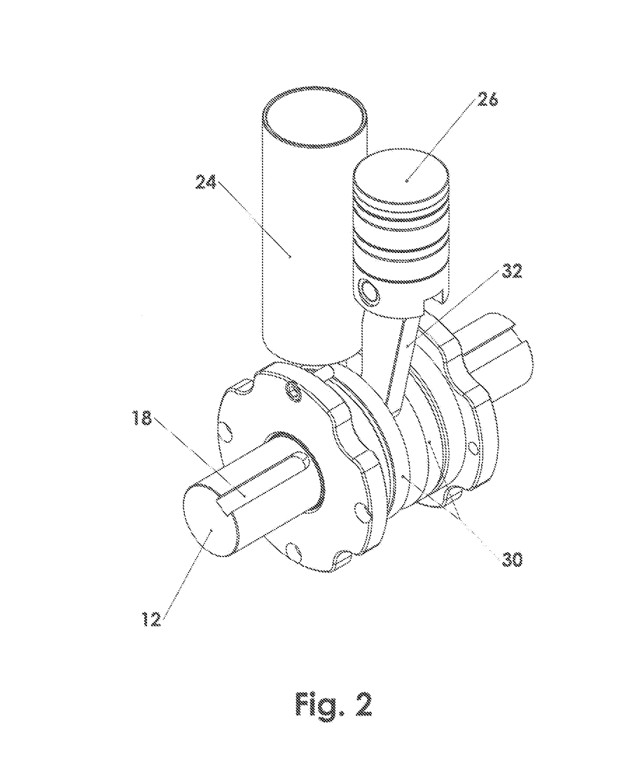

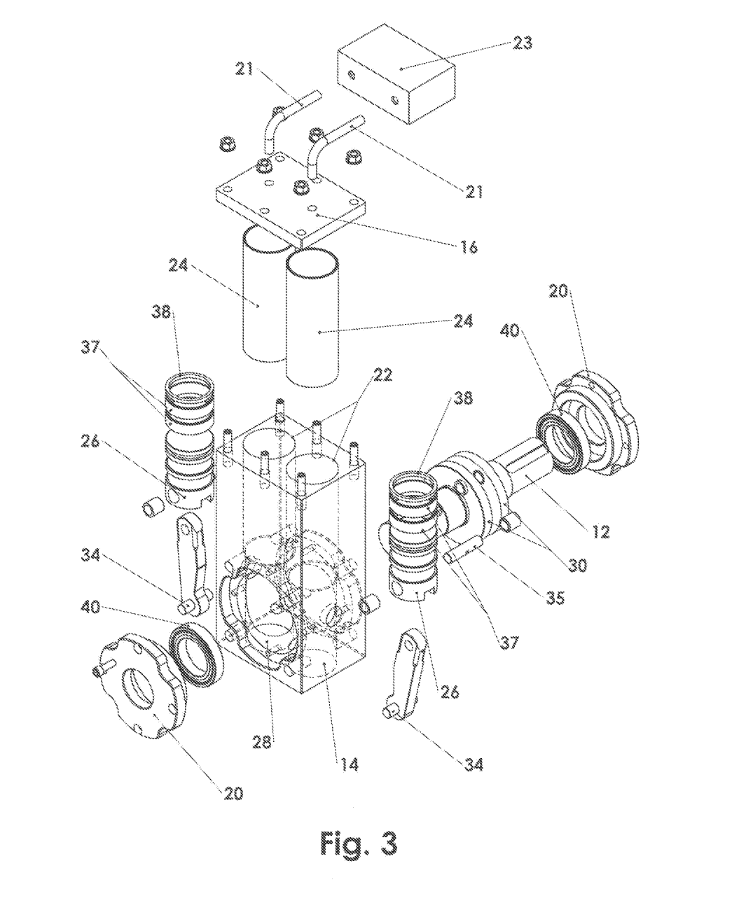

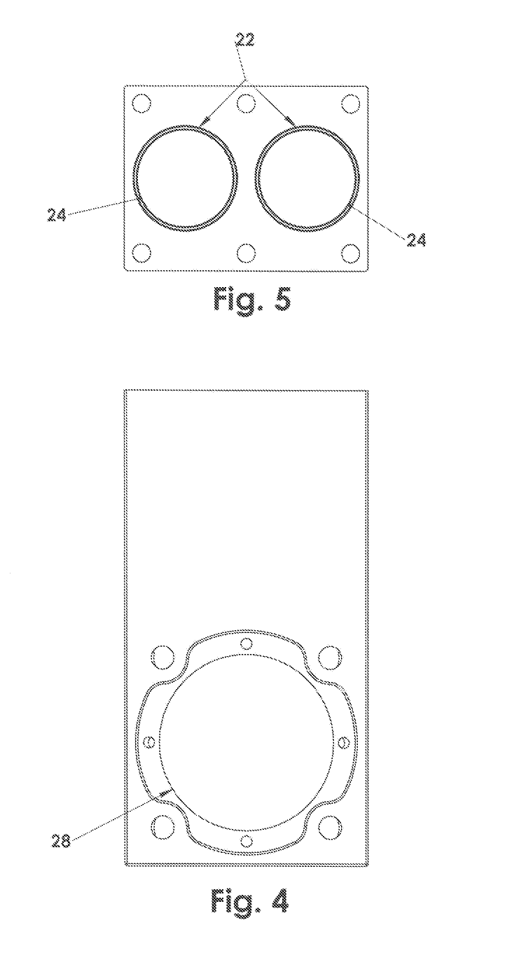

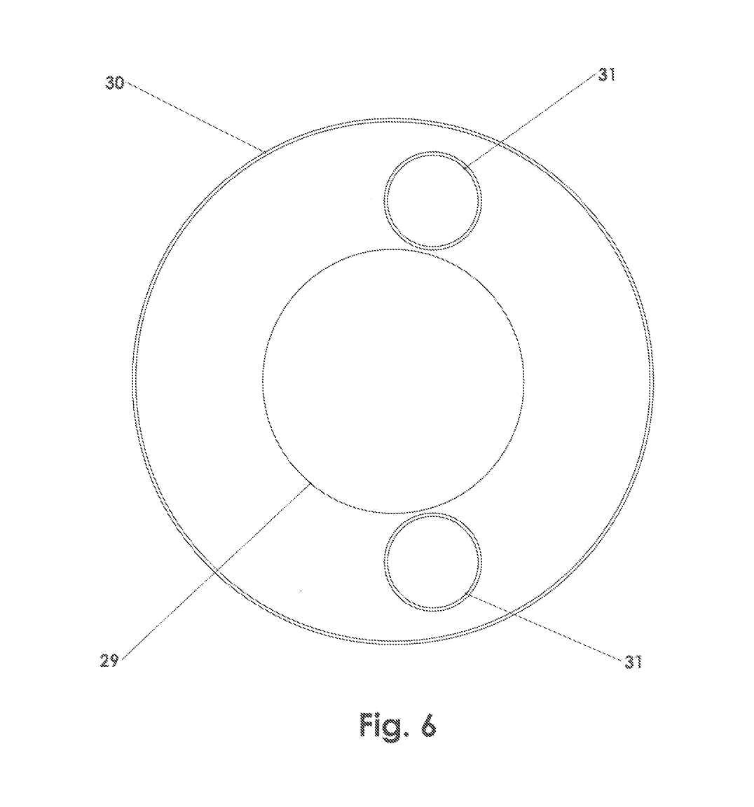

The hydraulic rotary actuator is illustrated in FIG. 2 with elements removed thereby allowing the internal elements to be more easily visualized. The hydraulic rotary actuator is illustrated in partial exploded view in FIG. 3. The casing is illustrated in isolated side view in FIG. 4 and in isolated top view in FIG. 5. The casing comprises, preferably parallel adjacent, cylinders 22 with an optional but preferred piston sleeve 24 as a cylinder liner therein. As would be realized from the drawings a pair of pistons 26 move in the cylinders in opposing phase. A crank bore 28 perpendicular to the cylinders receives the crankshaft comprising the shaft 12 with at least one pivot plate 30 mounted thereon. A single pivot plate can be employed but two pivot plates sandwiching connecting rods 32 there between is preferred for mechanical strength. A pivot plate is illustrated in side view in FIG. 6 wherein a central void 29 receives the shaft and is fixed to the shaft such that it rotates in concert with the shaft. Connector voids 31 which are symmetrically displaced, preferably by mirror symmetry, allow for the connector rods to be rotationally attached thereto by bottom connector pins 34 such that as the pivot plate rotates the connector rod persuades the piston to move laterally within the cylinder. Each piston 26 is pivotally attached to a connector rod by an upper connector pin 35 opposite the pivot plate. An optional but preferred wear band 37 and lip seal 38 are received by the piston. The wear band is a material which is a sacrificial replaceable wear surface thereby extending the life of the piston and either the cylinder or the piston liner. The lip seal is preferably a flexible material which forms a seal between the piston and either the cylinder or the piston sleeve to minimize hydraulic fluid from escaping from the compression area, or pressure zone, of the device. Optional bearings 40 receive the shaft wherein the bearings are received in a bearing race in the casing and secured in position by the bearing cap, 20. Bearing functionality may be integral to the case or integral to the bearing cap if desired.

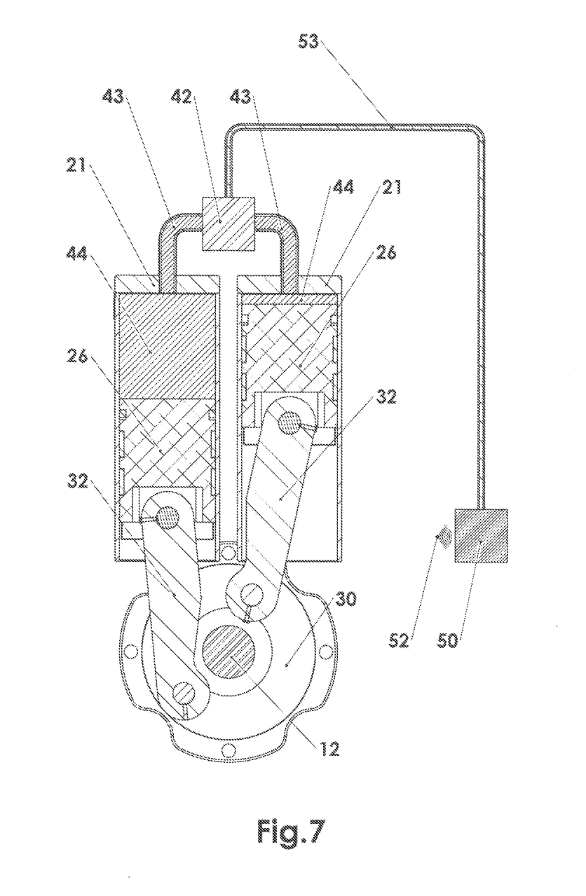

The operation of the hydraulic rotary actuator will be described with reference to FIG. 7 wherein a hydraulic rotary actuator 10 is illustrated in cross-sectional schematic view. In FIG. 7 the pistons 26 are coupled to the pivot plate 30 by connector rods 32 and therefore the pistons oscillate in the cylinders in opposite phase in concert with rotation of the pivot plate 30 and attached shaft 12. Each cylinder has a pressure zone 44 filled with a fluid wherein the pressure zone is defined as that area of varying dimension bound by the piston and the cylinder. As would be realized the pressure zone dimensions vary with piston movement and the adjacent pressure zones expand or contract in reverse synchronous fashion. The adjacent pressure zones are in flow connection through ports 21 with the flow between ports controlled by a controller 42. A sensor 50 capable of transmitting a signal 52 in communication with the hydraulic rotary actuator is provided wherein, based on the measurement received, the controller can alter flow between cylinders to allow control throughout the range of motion of the shaft. By way of example, in a rotational resistance mode, a shaft rotating in a clockwise fashion will force the left piston to rise and the right piston to lower with fluid flowing from the left pressure zone to the right pressure zone. The resistance to rotation will be defined by the difficulty associated with the fluid flow between pressure zones. If the fluid flow is restricted the resistance to rotation of the shaft is high and if flow resistance is lowered the resistance to rotation is lessened. By alternate way of example, in a powered rotation mode, controller 42 can remove fluid from the left pressure zone and deposit the fluid in the right pressure zone thereby persuading the right piston down and the left piston up. The piston movement would then persuade clockwise rotation of the pivot plate and therefore clockwise rotation of the shaft.

With further reference to FIG. 6 the length of travel of the piston in the cylinder is partly determined by the location of the connector voids 31 in the pivot plate 30. The further the connector voids are removed from center the larger the arc traveled by the connector void and therefore the further the piston can travel. As would be apparent, the travel is restricted by contact of the connector rod with either the shaft or a component of the opposite connector rod. Therefore, it is preferable for the connector rod to have a shape with a deviation away from any central contact point.

The fluid in the pressure zone is not particularly limited herein with liquid or gaseous fluids being suitable for demonstration of the invention. It is preferable that the fluid be non-compressible since compression of the fluid decreases control of the device. Hydraulic fluids are particularly suitable due to their ready availability and wide-spread use.

The controller can be a passive controller, which limits flow of fluid by restrictions, such as an orifice, or an active controller capable of actively moving fluid from one pressure zone to another. The controller can be a mechanical controller wherein the flow is restricted by mechanical manipulation of an orifice or flow path of fluid with the manipulation being done by human interface or by machine such as by manipulation of a needle valve or pump. Alternatively, the controller can be automated wherein the flow of fluid is controlled in response to a criteria, such as would be measured by the sensor, such as fluid pressure, rotational angle of the shaft, time or other criteria. In a particularly preferred embodiment the flow can be controlled by a controller which is interfaced with a microprocessor, or the like, thereby allowing the force required to rotate the shaft, or the rotational force applied to the shaft, to be a variable controllable anywhere within the rotational range of the shaft. By way of non-limiting example, starting from full counter-clockwise rotation, a first rotational resistance can be applied over an initial range of the rotation, first 20° for example, and the next range of rotation, second 20° for example, may have a higher or lower rotational resistance. Similiarly, the initial rotational force may be different than the rotational force in a second range of rotation. This control allows for a wide array of options such as increasing pressure as the rotational ranges are reached to avoid over rotation or a narrow range of rotation may be set for different applications. The controller may be configured to include, without limitation, an electronic adjustable valve, a magnetic adjustable valve, electronic HMI (Human Machine Interface), a PLC (Programmable Logic Controller), a PCB (Printed Circuit Board), a microcontroller, an I/O (Input/Output) module, a power supply, an encoder, and a pressure transducer all of which are well known commercially available control systems for devices and not further detailed herein.

A particular advantage is the ability to tailor the rotational resistance either prior to a particulary usage or during usage. The powered controller may include a pressure sensor, such as a pressure transducer, or a position sensor for each hydraulic rotational actuator thereby allowing for feedback to a microcontroller. The flow can then be controlled based on cylinder pressure, rotational angle of the shaft or combinations thereof to provide increased or decreased rotational resistance as a function of time, location or some combination thereof. By way of non-limiting example this allows certain areas of the range of motion to be restricted or for areas of the range of motion may have more or less resistance to enhance certain exercises. Exercises may therefore be designed wherein motions which are not ergonimically sound can be eliminated or restricted.

A particular advantage is the ability to tailor the rotational power imparted by the device either prior to a particular usage or during usage. The powered controller may include a pressure sensor, such as a pressure transducer, or a position sensor for each shaft thereby allowing for feedback to a microcontroller. The flow can then be controlled based on cylinder pressure, degree of rotation or combinations thereof to provide increased or decreased rotational resistance as a function of time, degree of rotation or some combination thereof. By way of non-limiting example this allows certain areas of the range of motion to receive more rotational force, such as when initially moving a stopped shaft, or for areas of the range of motion may have more or less rotational force.

The invention has been described with reference to preferred embodiments without limit thereto. One of skill in the art would realize additional embodiments and alterations which are not specifically set forth herein but which are within the scope of the invention as more specifically set forth in the claims appended hereto.

Claimed is:

1. A hydraulic rotational actuator comprising:
a casing comprising a pair of cylinders with fluid in each cylinder of said cylinders;
a pair of ports in flow communication within each other wherein each port of said ports is in flow relationship with a separate cylinder of said cylinders;
a controller capable of controlling flow of said fluid between said ports;
a pair of pistons wherein each piston of said pistons is in a separate cylinder and engaged with said fluid such that said piston moves in said cylinder in response to said fluid volume changing in said cylinder;
a pair of connector rods wherein each connector rod of said connector rods is pivotally attached to a separate piston;
a pivot plate pivotally connected to each said connector rod opposite said piston; and
a shaft attached to said pivot plate and adapted to rotate in concert with said pivot plate.

2. The hydraulic rotational actuator of claim 1 wherein said cylinders are parallel.

3. The hydraulic rotational actuator of claim 1 wherein said controller is selected from mechanical control and powered control.

4. The hydraulic rotational actuator of claim 1 wherein said controller is coupled with a sensor.

5. The hydraulic rotational actuator of claim 4 wherein said sensor detects at least one of pressure or position.

6. The hydraulic rotational actuator of claim 1 wherein at least one cylinder comprises a piston sleeve.

7. The hydraulic rotational actuator of claim 1 further comprising two pivot plates.

8. The hydraulic rotational actuator of claim 1 wherein said piston comprises at least one of a wear band or a lip seal.

9. The hydraulic rotational actuator of claim 1 wherein said controller comprises at least one of an electronic adjustable valve, a magnetic adjustable valve, electronic human machine interface, a programmable logic controller), a printed circuit board, a microcontroller, an input/output) module, a power supply, an encoder, and a pressure transducer.
